(19) United States
(12) Patent Application Publication
(10) Pub. No.: US 2025/0385583 A1
(43) Pub. Date: Dec. 18, 2025

(54) Vibration Motor

(71) Applicant: AAC Microtech (Changzhou) Co., Ltd., Changzhou City (CN)

(72) Inventors: Peng Cai, Changzhou (CN); Junsheng Wang, Changzhou (CN); Jie Wu, Changzhou (CN); Fali Zhong, Changzhou (CN)

(21) Appl. No.: 19/006,319

(22) Filed: Dec. 31, 2024

Related U.S. Application Data
(63) Continuation of application No. PCT/CN2024/099759, filed on Jun. 18, 2024.

(51) Int. Cl. H02K 33/18

(52) U.S. Cl. CPC H02K 33/18

(57) ABSTRACT

The present invention provides a vibration motor having a housing with a containment space, and guide components, vibration components and stator components contained within the containment space. The stator components include coil units arranged along a first direction and fixed to the housing, and two first magnetic spring units. The vibration component includes a magnetic unit and two second magnetic spring units. When the coil units are energized, the vibration components are driven to vibrate along the first direction, and the magnetic repulsion between the two first magnetic spring units and the corresponding second magnetic spring units provides a restoring force to the vibration components. The present invention improves the service life of the vibration motor, increases the amount of vibration, and enhances the vibration performance and reliability.

### TECHNICAL FIELD

This invention relates to the field of electromechanical devices, in particularly to a vibration motor.

### BACKGROUND

Existing vibration motors use a spring to connect the oscillating mass to form a vibration system, with the coil located below the oscillator's magnet. When the coil is energized, it generates a driving force in the magnetic field to make the oscillator move. However, the spring undergoes deformation stress during movement, and the greater the travel distance, the greater the stress. When the stress reaches the maximum service life of the spring material, the spring will break, leading to the failure of the vibration system.

Therefore, it is necessary to provide a vibration motor that does not have the traditional spring material deformation stress problem.

### SUMMARY

One of the purposes of the present invention is to provide a vibration motor to solve the technical problem of short lifespan of the vibration motor due to deformation stress in the spring.

To achieve the above purpose, the present invention provides a vibration motor, comprising: a housing with a containment space; a guide component fixed to the housing and extending along a first direction; a stator component, including a coil unit and two first magnetic spring units locating along the first direction, the two first magnetic spring units being symmetrically arranged on both sides of the coil unit and respectively fixed to the housing; a vibration component slidably connected to the guide component along the first direction, including a magnet unit and two second magnetic spring units arranged and fixed along the first direction, the magnet unit being inserted in the coil unit, and the two second magnetic spring units being symmetrically arranged on both sides of the magnet unit and spaced apart along the first direction between two first magnetic spring units.

The first magnetic spring unit and the second magnetic spring unit are magnetized along a second direction perpendicular to the first direction, and the magnetization directions of the first magnetic spring unit and the second magnetic spring unit are opposite to each other, for forming magnetic repulsive force between the two first magnetic spring units and corresponding second magnetic spring units which provides a restoring force to the vibration component for enabling the vibration component to perform reciprocating motion along the first direction.

As an improvement, the second magnetic spring unit comprises a second magnet part, the first magnetic spring unit comprises two first magnet parts arranged along the second direction and respectively located on both sides of the second magnet part, and the two first magnet parts are respectively arranged with a magnetic pole facing a same magnetic pole of the second magnet part.

As an improvement, the magnetic unit comprises at least two third magnet parts spaced along the first direction, and a fourth magnet part disposed between adjacent two third magnet parts; the third magnet parts and the fourth magnet part are fixed and magnetized along the first direction; the third magnet parts are magnetically oriented in the same direction relative to the adjacent fourth magnet parts; the coil unit comprises at least two coil parts arranged along the first direction, and the coil parts encompassing ends of the third magnet parts and adjacent fourth magnet parts.

As an improvement, the magnetic unit is magnetized as an integral unit, or alternatively, the magnetic unit is magnetized as separate units.

As an improvement, the magnetic unit further comprises a soft magnetic portion that is correspondingly arranged with the coil portion; the soft magnetic portion is fixed between adjacent third magnet parts and the fourth magnet part, and the soft magnetic portion is surrounded by the corresponding coil portion.

As an improvement, the soft magnetic portion is located in a middle of the corresponding coil portion when the coil unit is not energized.

As an improvement, the vibration component further comprises a first counterweight block and/or a second counterweight block, wherein the first counterweight block is connected to one end of the second magnetic spring unit away from the magnetic unit, and/or the second counterweight block is connected between the second magnetic spring unit and the magnetic unit.

As an improvement, the guide component comprises two guide sleeves, wherein the two guide sleeves are symmetrically arranged on both sides of the coil unit along the first direction, and the guide sleeves are located between the first magnetic spring unit and the coil unit, and the vibration component is slidably mounted along the first direction through the two guide sleeves.

As an improvement, the vibration component further comprises a clamp plate slidably connected to the guide component, the clamp plate being wrapped around the magnetic unit and the two second magnetic spring units along the first direction.

The vibration component is slidably connected to the guide component along a first direction, supported within the accommodating space through the guide component, providing a fixed position for the vibration component to move reciprocally along the first direction within the guide component, further enhancing the stability of the vibration motor, solving the problem of the vibration component losing support due to traditional spring material failure or detachment, more reliable. The coil unit is energized to drive the vibration component to vibrate along the first direction, magnetic repulsion is formed between two second magnetic spring units and their corresponding first magnetic spring units, and the two second magnetic spring units are spaced along the first direction between the two first magnetic spring units.

During the vibration process of the vibration component along the first direction, the greater the vibration displacement of the vibration component, the closer one of the second magnetic spring units is to its corresponding first magnetic spring unit, which provides greater effective restoring force for the vibration component between the two first magnetic spring units and their corresponding second magnetic spring units, ensuring that the vibration component can move reciprocally along the first direction, and the first magnetic spring units do not occupy the design dimensions of the first direction, solving the traditional spring material deformation stress problem, improving the service life of the vibration motor, with larger motion stroke, larger vibration amplitude, and improved vibration performance and reliability.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is a top view of a vibration motor in accordance with a first embodiment of the present invention.

FIG. 2 is a front view of the vibration motor in FIG. 1.

FIG. 3 is an isometric view of the vibration motor, with a housing thereof removed.

FIG. 4 is a cross-sectional view of the vibration motor, taken along line A-A in FIG. 1.

FIG. 5 is a cross-sectional view of the vibration motor taken along line B-B in FIG. 2, at a first state.

FIG. 6 is an isometric view of a vibration motor in accordance with a second embodiment of the present invention, with a housing thereof removed.

FIG. 7 is an isometric view of the vibration motor in FIG. 6, with a coil unit, guide component, and part of clamping plates of the vibration motor removed.

FIG. 8 is a cross-sectional view of the vibration motor taken along line B-B in FIG. 2, at a second state.

FIG. 9 is an isometric view of a vibration motor in accordance with a third embodiment of the present invention, with a part of a housing thereof removed.

FIG. 10 is an isometric view of the vibration motor in FIG. 9, with a coil unit, guide component, and part of clamping plates of the vibration motor removed.

FIG. 11 is a cross-sectional view of the vibration motor taken along line B-B in FIG. 2, at a third state.

### DETAILED DESCRIPTION OF THE EMBODIMENTS

The following will be taken in conjunction with the accompanying drawings of embodiments of the present invention. The technical scheme in the embodiment of the invention is clearly and completely described. Obviously, the described embodiments are merely part of the embodiments of the present invention, and not all embodiments are based on the embodiments of the present invention, and all other embodiments attained by those of ordinary skill in the art without inventive effort are within the scope of the present invention.

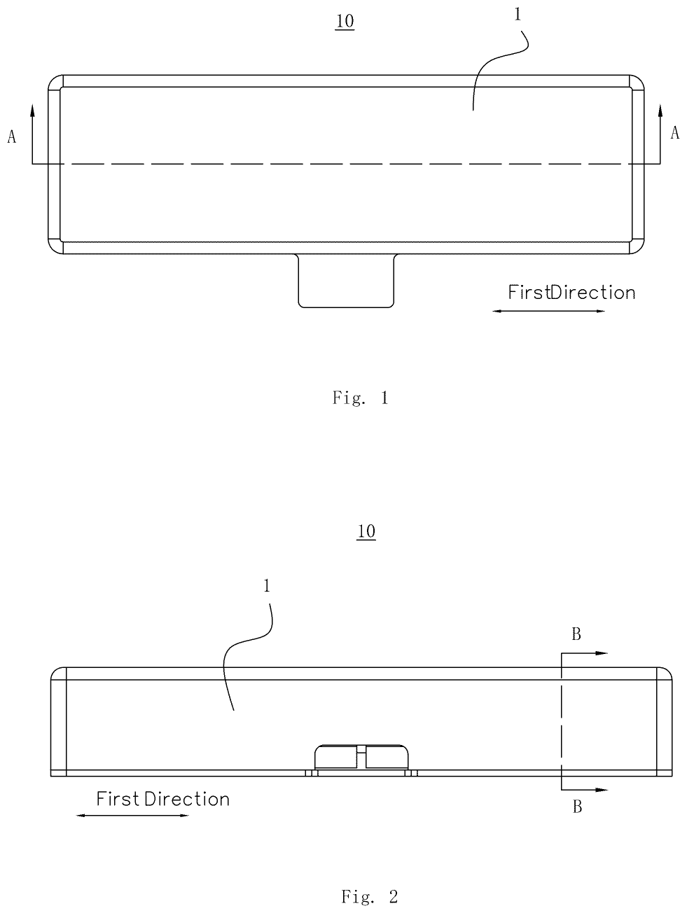

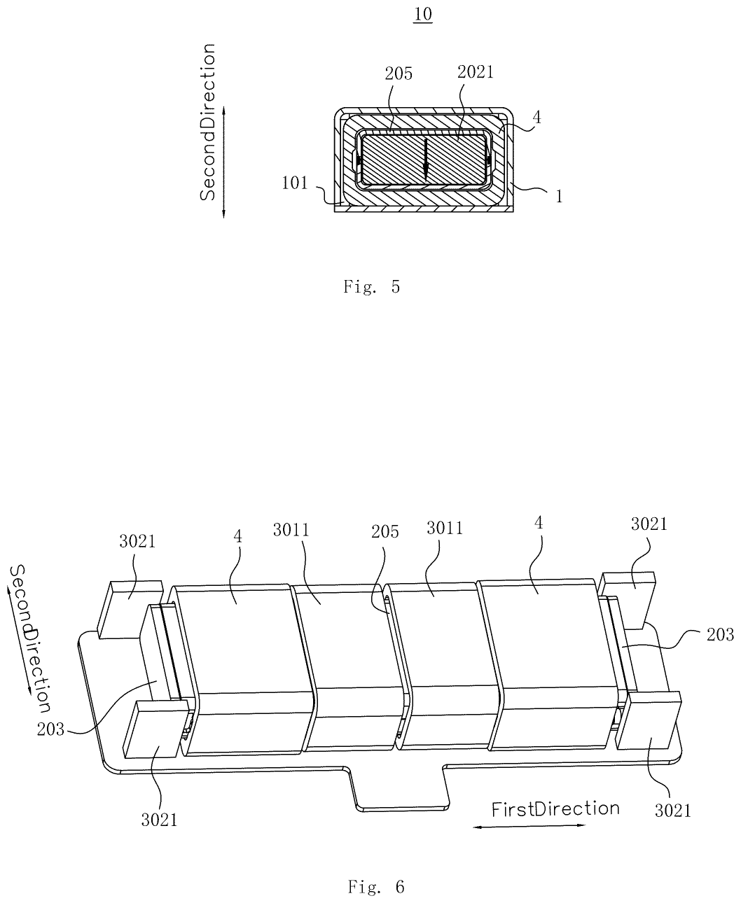

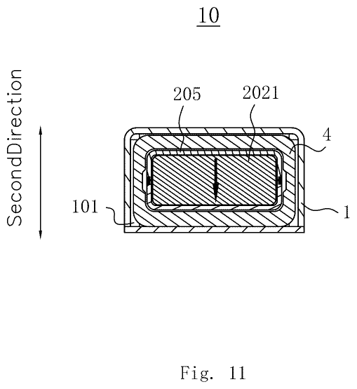

A first embodiment of the present invention provides a vibration motor 10, comprising a housing 1, a vibration component 2, a stator component 3, and a guide component, as shown in FIGS. 1-11. The housing 1 has a containment space 101. The guide component, vibration component 2, and stator component 3 are received in the containment space 101. The guide component is fixed to the housing 1. The stator component 3 includes a coil unit 301 and two first magnetic spring units 302. The coil unit 301 and two first magnetic spring units 302 are arranged along a first direction, and the coil unit 301 and two first magnetic spring units 302 are respectively fixed to the housing 1, with the two first magnetic spring units 302 symmetrically arranged on both sides of the coil unit 301.

The vibration component 2 is slidably inserted into the guide component along the first direction. The vibration component 2 includes a magnet unit 201 and two second magnetic spring units 202. The magnet unit 201 is inserted through the coil unit 301, and the magnet unit 201 and two second magnetic spring units 202 are arranged along the first direction and fixed as a whole, with the two second magnetic spring units 202 symmetrically arranged on both sides of the magnet unit 201. The two second magnetic spring units 202 are spaced along the first direction between the two first magnetic spring units 302. The first magnetic spring units 302 and the second magnetic spring units 202 are magnetized along a second direction perpendicular to the first direction, and the magnetization directions of the first magnetic spring units 302 and the second magnetic spring units 202 are opposite. When the coil unit 301 is energized, it drives the vibration component 2 to vibrate along the first direction, and the magnetic repulsion force between the two first magnetic spring units 302 and the corresponding second magnetic spring units 202 provides a restoring force to the vibration component 2, causing the vibration component 2 to reciprocate along the first direction.

In the present embodiment, please refer to FIG. 4. The vibration component 2 can slide along the first direction and pass through the guide component. The vibration component 2 is supported inside the containment space 101 by the guide component, providing a fixed position for the vibration component 2 to move back and forth along the first direction, which further improves the stability of the vibration motor and solves the problem of the vibration component 2 losing support due to the failure or detachment of the traditional spring material, making it more reliable. After the coil unit 301 is energized, it drives the vibration component 2 to vibrate along the first direction. A magnetic repulsion force is formed between the two second magnetic spring units 202 and the corresponding first magnetic spring unit 302. Moreover, the two second magnetic spring units 202 are arranged at intervals along the first direction between the two first magnetic spring units 302. During the vibration process of the vibration component 2 along the first direction, the greater the vibration displacement of the vibration component 2, the closer one of the second magnetic spring units 202 is to the corresponding first magnetic spring unit 302, and the greater the magnetic repulsion force between them. This provides the vibration component 2 with effective restoring force from the magnetic repulsion force between the two first magnetic spring units 302 and the corresponding second magnetic spring units 202, ensuring that the vibration component 2 can move back and forth along the first direction.

The first magnetic spring unit 302 and the second magnetic spring unit 202 cooperate to form a magnetic spring system, replacing the traditional motor spring. Moreover, the first magnetic spring unit 302 does not occupy the design dimension of the first direction, not only solving the problem of large deformation stress and spring fracture in the motion process of the traditional motor spring, improving the service life of the vibration motor 10, but also having a larger travel range and vibration amplitude than the traditional motor spring. It also improves the vibration performance and reliability of the vibration motor 10.

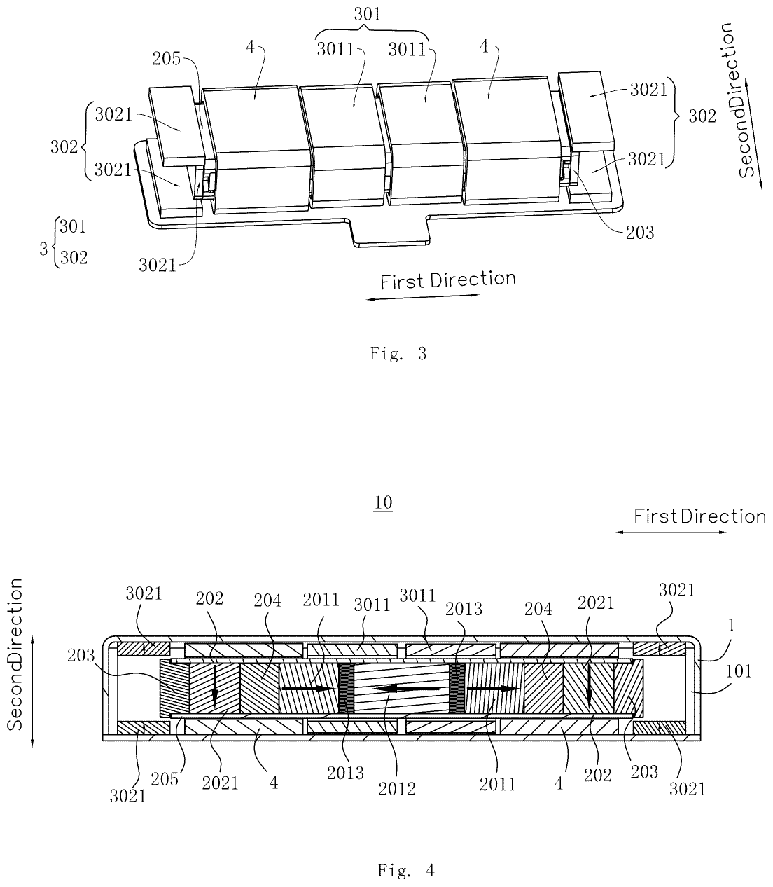

In some preferred embodiments, please refer to FIGS. 3-4, 6, 7, 9-10. Each second magnetic spring unit 202 includes a second magnet part 2021. Each first magnetic spring unit 302 includes two first magnet parts 3021. The two first magnet parts 3021 in the same first magnetic spring unit 302 are arranged along a second direction. Moreover, the two first magnet parts 3021 in the same first magnetic spring unit 302 are symmetrically located on the two sides of the corresponding second magnet part 2021, so that the second magnet part 2021 is subjected to more balanced and stable force, further improving the stability of the vibration motor 10. Furthermore, the two first magnet parts 3021 in the same first magnetic spring unit 302 are respectively arranged opposite to the corresponding second magnet part 2021 in the same magnetic pole orientation, utilizing the same-pole repulsion principle to generate repulsion force, forming a magnetic spring system to replace traditional springs, so that the first magnetic spring unit 302 can provide restoring force to the vibration component 2.

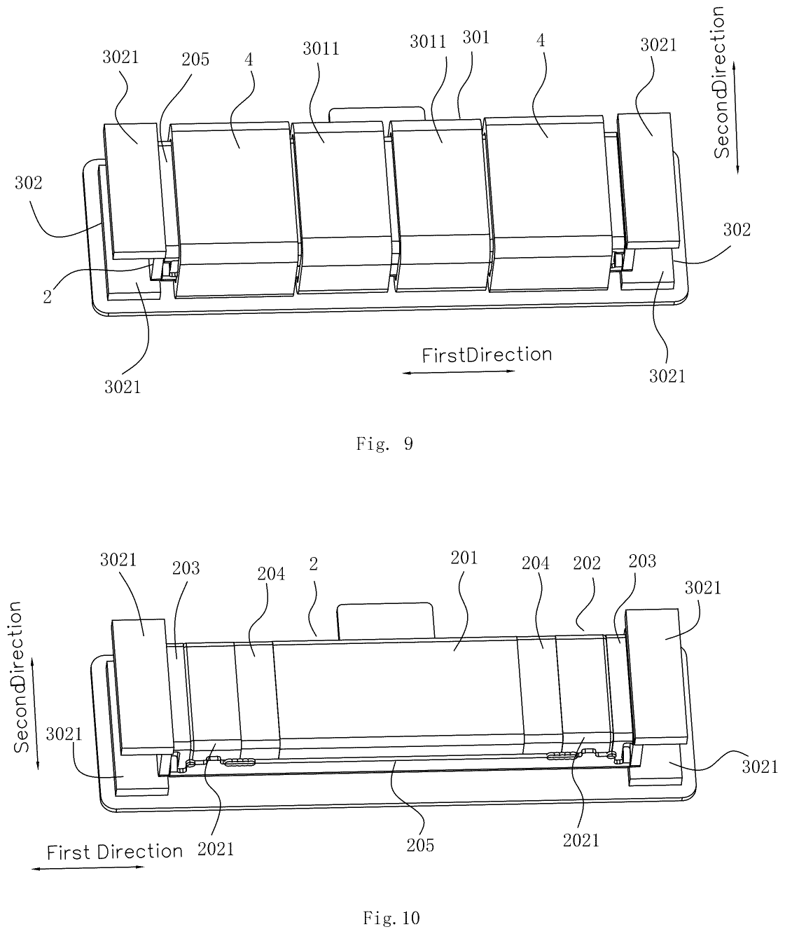

In some embodiments, please refer to FIGS. 3-5, and refer to FIGS. 9-11. The first direction is the left and right direction shown in FIG. 3, FIG. 4, FIG. 9 and FIG. 10, and the second direction is the up and down direction shown in FIG. 3 to FIG. 5 and FIG. 9 to FIG. 11. Please refer to FIG. 3 and FIG. 4, as well as FIG. 9 and FIG. 10, where two first magnet parts 3021 of the same first magnetic spring unit 302 are symmetrically arranged on the upper and lower sides of the corresponding second magnet part 2021. The magnetization direction of the first magnet part 3021 and the magnetization direction of the second magnet part 2021 are both up and down.

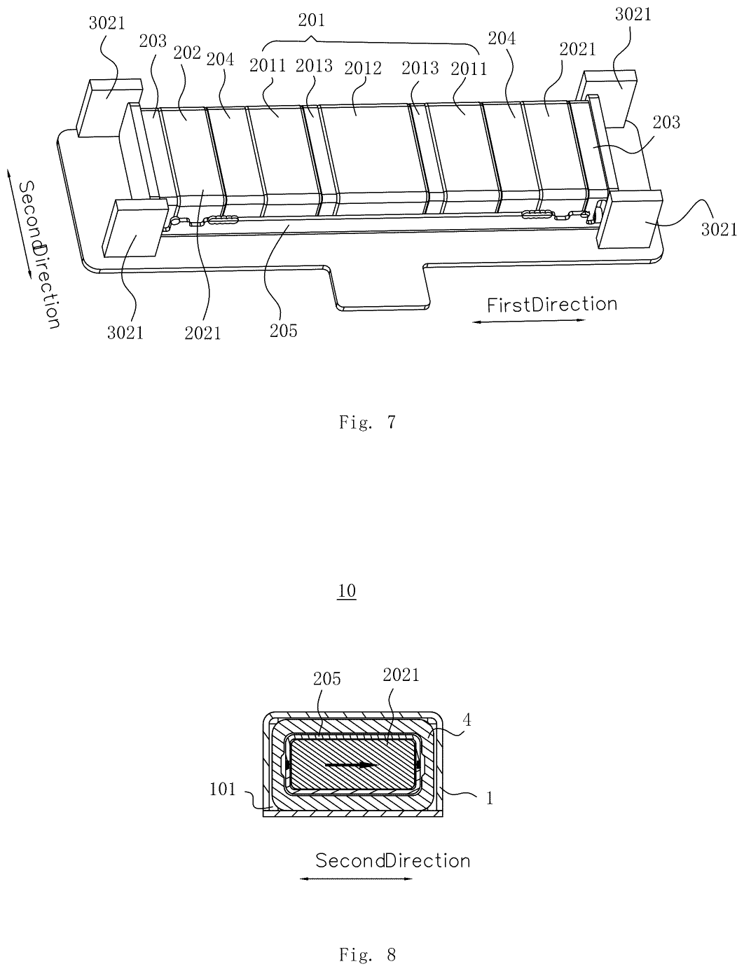

Refer to FIGS. 6-8, the first direction refers to the left and right directions shown in FIG. 6 and FIG. 7, and the second direction refers to the front and back directions shown in FIG. 6 and FIG. 7, as well as the left and right directions shown in FIG. 8. The two first magnet parts 3021 of the same first magnetic spring unit 302 are symmetrically arranged on the front and back sides of the corresponding second magnet part 2021. The magnetization direction of the first magnet part 3021 and the magnetization direction of the second magnet part 2021 are magnetized in the front and back directions.

In some examples, the first magnet part 3021 is made of permanent magnet material, with strong magnetic properties, good stability, long service life, and high efficiency and energy saving. The second magnet part 2021 is made of permanent magnet material, with strong magnetic properties, good stability, long service life, and high efficiency and energy saving.

As an illustrative example, permanent magnet materials can be neodymium iron boron materials. It can be understood that permanent magnet materials can also be other permanent magnet materials, which are not further elaborated here.

Please refer to FIG. 4 and FIG. 7, the magnetic unit 201 includes a third magnet part 2011 and a fourth magnet part 2012. Among them, there are at least two third magnet parts 2011, and all third magnet parts 2011 are spaced apart along the first direction. There is at least one fourth magnet part 2012, and a fourth magnet part 2012 is set between every two adjacent third magnet parts 2011, that is, the fourth magnet part 2012 is set between two adjacent third magnet parts 2011. The fourth magnet part 2012 and the third magnet part 2011 are fixed together, and the third magnet part 2011 and the fourth magnet part 2012 are magnetized along the first direction respectively, and the magnetic poles of the third magnet part 2011 and the adjacent fourth magnet part 2012 are set in the same orientation, so as to generate a strong magnetic field. The coil unit 301 includes at least two coil parts 3011, and all coil parts 3011 are set along the first direction. Each coil part 3011 surrounds the ends of the third magnet part 2011 and the adjacent fourth magnet part 2012, and the third magnet part 2011 and the fourth magnet part 2012 generate a magnetic field. The coil part 3011, when energized, generates a driving force in the magnetic field, thereby driving the vibration component 2 to vibrate along the first direction.

In some examples, the third magnet part 2011 is a permanent magnet material with strong magnetic properties, good stability, long service life, and high efficiency energy saving. The fourth magnet part 2012 is a permanent magnet material with strong magnetic properties, good stability, long service life, and high efficiency energy saving.

As an example, permanent magnet materials can be neodymium iron boron materials. It can be understood that permanent magnet materials can also be other permanent magnet materials, which will not be further elaborated here.

In some examples, please refer to the examples shown in FIG. 4 and FIG. 7, the magnetic unit 201 includes two third magnet parts 2011 and one fourth magnet part 2012. The two third magnet parts 2011 are spaced along the first direction, the fourth magnet part 2012 is located between the two third magnet parts 2011, and the fourth magnet part 2012 is fixed with the two third magnet parts 2011. The two third magnet parts 2011 and the fourth magnet part 2012 are magnetized along the first direction, and the two third magnet parts 2011 are magnetically disposed in the same polarity relative to the fourth magnet part 2012, thereby generating a strong magnetic field. The coil unit 301 includes two coil parts 3011, the two coil parts 3011 are arranged along the first direction, one coil part 3011 surrounds the end portion of one third magnet part 2011 and the fourth magnet part 2012, while the other coil part 3011 surrounds the end portion of the other third magnet part 2011 and the fourth magnet part 2012. The two third magnet parts 2011 and the fourth magnet part 2012 generate a magnetic field, and the energized coil parts 3011 generate driving force in the magnetic field, thereby driving the vibration component 2 to vibrate along the first direction.

It is understandable that the quantity and size of the third magnet part in 2011, the fourth magnet part in 2012, and the coil part in 3011 can be determined according to the size of the vibration motor 10, and the quantity and size of the third magnet part in 2011, the fourth magnet part in 2012, and the coil part in 3011 can be increased or decreased according to specific situations.

Optionally, the magnet unit 201 is magnetized as a whole, please refer to FIG. 10, that is, the third magnet part 2011 and the fourth magnet part 2012 are magnetized as a whole, which can simplify the assembly process and improve production efficiency.

Optionally, the magnetic unit 201 is magnetized separately. Please refer to the examples shown in FIG. 4 and FIG. 7. That is to say, the third magnet part 2011 and the fourth magnet part 2012 are magnetized separately. It has high flexibility and is convenient for maintenance and replacement of parts.

Optionally, please refer to FIGS. 4 and 7, the magnetic unit 201 may also include at least two soft magnetic portions 2013. The soft magnetic portions 2013 can be correspondingly arranged with the coil portion 3011. The soft magnetic portion 2013 is fixed between adjacent third magnet part 2011 and fourth magnet part 2012, and the soft magnetic portion 2013 is surrounded and enveloped inside the corresponding coil portion 3011. The third magnet part 2011 and fourth magnet part 2012 can generate a magnetic field, the coil portion 3011 can generate a driving force in the magnetic field when energized, the soft magnetic portion 2013 can enhance the magnetic field, thus increasing the driving force.

It is understandable that the soft magnetic part in 2013 is made of soft magnetic materials. As an example, the soft magnetic material can be carbon steel, or the soft magnetic material can be iron-cobalt material, or the soft magnetic material can be amorphous soft magnetic material, or the soft magnetic material can be nanocrystalline soft magnetic material, or the soft magnetic material can be other soft magnetic materials, which are not elaborated here.

As a preferred implementation method, please refer to FIG. 4. In the case where the coil unit 301 is not energized, which is the initial state, the vibration component 2 is in a balanced state, and the soft magnetic part 2013 is positioned in the middle of the corresponding coil part 3011. At this time, the maximum use of the magnetic field can generate greater driving force.

In some preferred embodiments, the vibration component 2 may further comprise a first counterweight block 203 and/or a second counterweight block 204. Please refer to FIGS. 4, 7, and 10, where the first counterweight block 203 is connected to one end of the second magnetic spring unit 202 away from the magnetic unit 201, and the second counterweight block 204 is connected between the second magnetic spring unit 202 and the magnetic unit 201. The first counterweight block 203 can provide greater weight to the vibration component 2, enhancing the vibration magnitude of the vibration motor 10. Similarly, the second counterweight block 204 can also provide greater weight to the vibration component 2, enhancing the vibration magnitude of the vibration motor 10.

Optionally, please refer to FIGS. 4, 7, and 10, the vibration component 2 includes both the first counterweight block 203 and the second counterweight block 204 simultaneously. There are two first counterweight blocks 203, with one of the first counterweight blocks 203 connected to one end of one of the second magnetic spring units 202 away from the magnetic unit 201, and the other first counterweight block 203 connected to the other end of the other second magnetic spring unit 202 away from the magnetic unit 201. There are two second counterweight blocks 204, with one of the second counterweight blocks 204 connected between one of the second magnetic spring units 202 and the magnetic unit 201, and the other second counterweight block 204 connected between the other second magnetic spring unit 202 and the magnetic unit 201. The first counterweight blocks 203 and the second counterweight blocks 204 can provide greater weight to the vibration component 2, enhancing the vibration of the vibration motor 10.

Alternatively, the vibration component 2 can only include the first counterweight block 203, or the vibration component 2 can only include the second counterweight block 204, or the vibration component 2 can not include any counterweight blocks, which can be set according to actual needs, without going into details here.

Please refer to FIGS. 3, 4, 6, and 9. The guide components include two guide sleeves 4, which are symmetrically arranged on both sides of the coil unit 301 via the first direction. Moreover, the guide sleeves 4 are located between the first magnetic spring unit 302 and the coil unit 301. The vibration component 2 can slide through the two guide sleeves 4 along the first direction. This not only does not increase the size of the vibration motor but also provides a fixed position for the vibration component 2, allowing it to reciprocate along the first direction in the guide sleeves 4, thereby further improving the stability of the vibration motor 10.

Please refer to FIGS. 3, 4, 6, and 9. Two guide sleeves 4 are respectively fixed to the housing 1, with one guide sleeve 4 positioned between one of the first magnetic spring units 302 and one of the coil sections 3011, and the other guide sleeve 4 positioned between the other first magnetic spring unit 302 and the other coil section 3011. The vibration component 2 is simultaneously inserted into the two guide sleeves 4. The two guide sleeves 4 can simultaneously provide a fixed position for the vibration component 2, enabling the vibration component 2 to reciprocate along the first direction in the two guide sleeves 4, further improving the stability of the vibration motor 10.

As an example, guide sleeve 4 can be made of wear-resistant materials such as plastic or alloy. It can be understood that guide sleeve 4 can also be made of other wear-resistant materials.

Optionally, the guide component can also be a guide rod, or the guide component can also be a slide rail, or the guide component can also be other guide structures, which can be set according to the actual situation, without going into details here.

Please refer to FIGS. 4, 5, 8, and 11. The vibration component 2 also includes a clamp plate 205, which is slidably connected to the guide component. The magnetic unit 201 and the second magnetic spring unit 202 can be fixed inside the clamp plate 205. The clamp plate 205 can be responsible for friction contact with the guide component, protecting the vibration component 2. This can prevent friction between the magnetic unit 201 and the second magnetic spring unit 202 and the stator component 3, thus protecting the magnetic unit 201 and the second magnetic spring unit 202 and avoiding damage to them during movement, further improving the service life of the vibration motor 10.

The baffles 205 may be made of non-magnetic materials.

It is understood that the clamping plate 205 can also partially cover the first balance block 203 and/or the second balance block 204 in the case of the vibration component 2 including the first balance block 203 and/or the second balance block 204, in order to protect the first balance block 203 and/or the second balance block 204.

The vibration motor 10 may also include a circuit board, which is electrically connected to the coil unit 301 to supply power to the coil unit 301. As an illustrative example, the circuit board can be at least partially housed within the containment space 101 to protect the circuit board and provide a more stable electrical connection between the circuit board and the coil unit 301, thereby stabilizing the structure of the vibration motor 10.

The foregoing is merely illustrative of embodiments of the present invention, and it should be noted that modifications may be made to those skilled in the art without departing from the spirit of the invention but are intended to be within the scope of the inventio.

What is claimed is:

1. A vibration motor, comprising:
a housing with a containment space;
a guide component fixed to the housing and extending along a first direction;
a stator component, including a coil unit and two first magnetic spring units locating along the first direction, the two first magnetic spring units being symmetrically arranged on both sides of the coil unit and respectively fixed to the housing;
a vibration component slidably connected to the guide component along the first direction, including a magnet unit and two second magnetic spring units arranged and fixed along the first direction, the magnet unit being inserted in the coil unit, and the two second magnetic spring units being symmetrically arranged on both sides of the magnet unit and spaced apart along the first direction between two first magnetic spring units; wherein
the first magnetic spring unit and the second magnetic spring unit are magnetized along a second direction perpendicular to the first direction, and the magnetization directions of the first magnetic spring unit and the second magnetic spring unit are opposite to each other, for forming magnetic repulsive force between the two first magnetic spring units and corresponding second magnetic spring units which provides a restoring force to the vibration component for enabling the vibration component to perform reciprocating motion along the first direction.

2. The vibration motor as described in claim 1, wherein the second magnetic spring unit comprises a second magnet part, the first magnetic spring unit comprises two first magnet parts arranged along the second direction and respectively located on both sides of the second magnet part, and the two first magnet parts are respectively arranged with a magnetic pole facing a same magnetic pole of the second magnet part.

3. The vibration motor as described in claim 1, wherein the magnetic unit comprises at least two third magnet parts spaced along the first direction, and a fourth magnet part disposed between adjacent two third magnet parts; the third magnet parts and the fourth magnet part are fixed and magnetized along the first direction; the third magnet parts are magnetically oriented in the same direction relative to the adjacent fourth magnet parts; the coil unit comprises at least two coil parts arranged along the first direction, and the coil parts encompassing ends of the third magnet parts and adjacent fourth magnet parts.

4. The vibration motor as described in claim 3, wherein the magnetic unit is magnetized as an integral unit, or alternatively, the magnetic unit is magnetized as separate units.

5. The vibration motor as described in claim 3, wherein the magnetic unit further comprises a soft magnetic portion that is correspondingly arranged with the coil portion; the soft magnetic portion is fixed between adjacent third magnet parts and the fourth magnet part, and the soft magnetic portion is surrounded by the corresponding coil portion.

6. The vibration motor as described in claim 3, wherein the soft magnetic portion is located in a middle of the corresponding coil portion when the coil unit is not energized.

7. The vibration motor as described in claim 1, wherein the vibration component further comprises a first counterweight block and/or a second counterweight block, wherein the first counterweight block is connected to one end of the second magnetic spring unit away from the magnetic unit, and/or the second counterweight block is connected between the second magnetic spring unit and the magnetic unit.

8. The vibration motor as described in claim 1, wherein the guide component comprises two guide sleeves, wherein the two guide sleeves are symmetrically arranged on both sides of the coil unit along the first direction, and the guide sleeves are located between the first magnetic spring unit and the coil unit, and the vibration component is slidably mounted along the first direction through the two guide sleeves.

9. The vibration motor as described in claim 1, wherein the vibration component further comprises a clamp plate slidably connected to the guide component, the clamp plate being wrapped around the magnetic unit and the two second magnetic spring units along the first direction.
